(19) United States
(12) Patent Application Publication
(10) Pub. No.: US 2018/0281114 A1
(43) Pub. Date: Oct. 4, 2018

(54) METHOD FOR BUILD-UP WELDING WITH OSCILLATING SOLIDIFICATION FRONT BY DEFINING PARAMETERS OF THE BUILD-UP WELDING

(71) Applicants: SIEMENS AKTIENGESELLSCHAFT, München (DE); FRAUNHOFER GESELLSCHAFT ZUR FÖRDERUNG DER ANGEWANDTEN FORSCHUNG E.V., MÜNCHEN (DE)

(72) Inventors: NIKOLAI ARJAKINE, BERLIN (DE); GEORG BOSTANJOGLO, BERLIN (DE); BERND BURBAUM, FALKENSEE (DE); ANDRES GASSER, AACHEN (DE); STEFANIE LINNENBRINK, KREUZAU (DE); FRANK MENTZEL, AACHEN (DE); MICHAEL OTT, MÜLHEIM AN DER RUHR (DE); NORBERT PIRCH, AACHEN (DE)

(21) Appl. No.: 15/772,536

(22) PCT Filed: Oct. 12, 2016
(86) PCT No.: PCT/EP2016/074482

§ 371 Date: May 1, 2018

(30) Foreign Application Priority Data
Nov. 10, 2015 (DE) 10 2015 222 084.2

(51) Int. Cl. B23K 26/342; B23K 26/00; B23K 26/08; B23K 26/073

(52) U.S. Cl. CPC B23K 26/342; B23K 26/0006; B23K 2201/001; B23K 26/073; B23K 26/0876

(57) ABSTRACT

Provided are build-up welds which are achieved by means of a targeted frequency selection and an amplitude which relates to the diameter of the energy beam.

### CROSS REFERENCE TO RELATED APPLICATIONS

This application claims priority to PCT Application No. PCT/EP2016/074482 having a filing date of Oct. 12, 2016, based on German Application No. 10 2015 222 084.2, having a filing date of Nov. 10, 2015, the entire contents both of which are hereby incorporated by reference.

### FIELD OF TECHNOLOGY

The following relates to build-up welding in which the solidification front oscillates.

### BACKGROUND

The following relates to build-up welding, in particular by way of pulverulent additives, while using a pendulum motion (wobble strategy). On account of this oscillation in build-up welding, a nucleation and a grain growth can be influenced in a targeted manner in the mushy zone, such that the growth of a columnar-phase solidification front is suppressed or is completely avoided, respectively. A very fine granular structure having grain sizes that are much smaller than the layer height generated results herein in the microstructure.

### SUMMARY

An aspect relates to the columnar-phase solidification and to improving the wobble strategy.

### BRIEF DESCRIPTION

Some of the embodiments will be described in detail, with references to the following figures, wherein like designations denote like members, wherein:

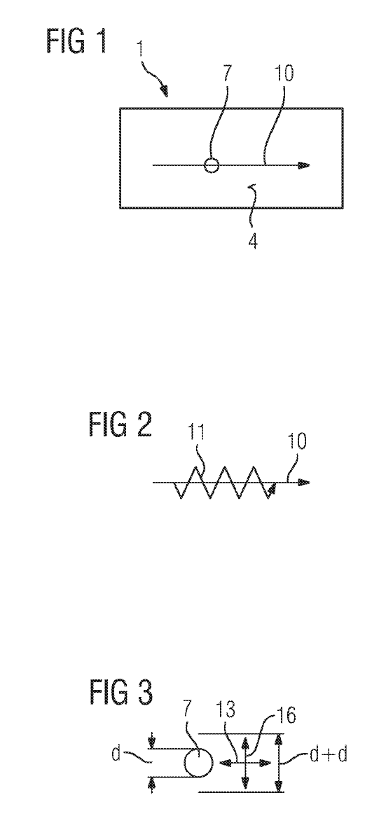

FIG. 1 shows an arrangement and a procedure according to the prior art;

FIG. 2 shows an oscillation movement of the laser beam; and

FIG. 3 shows a design embodiment of the method according to embodiments of the invention.

### DETAILED DESCRIPTION

The figure and the description represent only exemplary embodiments of the invention.

The advantages include improved material properties of the component as compared to components welded in a conventional manner.

It is illustrated in FIG. 1 how a component 1, in particular a turbine component, having a surface 4 is machined by means of an energy beam 7.

The machining is build-up welding, in particular laser build-up welding, in which an energy beam 7, in particular a laser beam 7, by way of the diameter d thereof at the machining location, in particular in the focal point, is moved along a movement direction 10. The general movement direction 10 in particular is linear and represents the superposed overall direction of an oscillating or reciprocating movement 11 (FIG. 2).

The zigzag illustration (FIG. 2) of the oscillating movement 11 is only one example of an oscillating movement of the laser beam. Movement, or advancement, respectively, always refers to a relative movement between the laser beam 7 and the substrate 4.

The term “linear” can also be understood to include meandering movement patterns for an area to be coated, that is to say that the resulting forward movement is linear.

According to embodiments of the invention, the solidification front of the applied material is left to oscillate. The laser beam 7 herein oscillates along the direction 13 of the advancement, and/or perpendicularly thereto in the direction 16.

The amplitude at which the laser beam oscillates is between 35% and 65% of the diameter d, or 70% to 130% of the radius of the laser beam at the machining location 7 (FIG. 3): x=(0.35-0.65) d; in particular, the amplitude x=½ d=r.

There is an upper limit for the frequency beyond which an improvement is no longer achieved for each speed of the “scanner” of the laser beam and of the amplitude.

The frequency at which the laser beam 7 reciprocates between two deflections is between 20 Hz and 50 Hz, in particular between 30 Hz and 40 Hz, most particularly 35 Hz.

The diameter of the laser beam 7 is preferably 500 μm to 1200 μm, most preferably 600 μm to 800 μm.

The general advancement speed is preferably 500 mm/min.

A higher frequency has to be set for a higher advancement speed. In particular, a frequency of 70 Hz would be expedient for an advancement of 1000 mm/min. Which frequency is suitable depends on the advancement. The latter has to be set such that the resulting track does not appear as a zigzag track but is configured such that the track geometry is like that of a conventionally welded track.

If the frequency is too high, the effect of the fresh formation of grain no longer arises.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for build-up welding having an oscillating solidification front, in which an energy beam, oscillates, wherein the energy beam oscillates at a frequency of 20 Hz to 50 Hz, and an amplitude of the oscillation is between 35% and 65% of diameter of the energy beam at machining location.

2. The method as claimed in claim 1, wherein the powder build-up welding laser powder build-up welding.

3. The method as claimed in claim 1, wherein a component from a nickel-based or cobalt-based super alloy is build-up welded.

4. The method as claimed in claim 1, wherein the diameter of the laser radiation at the machining location is 500 μm to 1200 μm.

5. The method as claimed in claim 1, wherein an advancement speed is between 400 mm/min and 600 mm/min.

6. The method as claimed in claim 1, wherein the energy beam oscillates at a frequency of 35 Hz.

7. The method as claimed in claim 1, wherein the amplitude of the oscillation is 50%.

8. The method as claimed in claim 1, wherein the machining location is a focal point.

9. The method as claimed in claim 4, wherein the diameter at the machining location is 600 μm to 800 μm.

10. The method as claimed in claim 5, wherein the advancement speed is between 500 mm/min.
